(19) United States
(12) Patent Application Publication
(10) Pub. No.: US 2026/0119231 A1
(43) Pub. Date: Apr. 30, 2026

(54) Controlled Transfer of Operation Between Devices Based on Thermal State

(71) Applicant: Google LLC, Mountain View, CA (US)

(72) Inventors: Chihhao Lee, New Taipei City (TW); Kuan-Yin Liu, New Taipei City (TW); Wu-Lin Tsai, Taoyuan City (TW); Hung-Ren Yu, Kaohsiung City (TW); Hsu Chung, Taoyuan City (TW); Liting Chiu, New Taipei City (TW)

(21) Appl. No.: 18/927,443

(22) Filed: Oct. 25, 2024

(51) Int. Cl. G06F 9/48; G06F 1/20

(52) U.S. Cl. CPC G06F 9/4856; G06F 1/206

(57) ABSTRACT

A method, apparatus, and system for use of device temperature as a basis to control transfer of an operation from one device to another, as a technique that may help to avoid thermal throttling and associated user-experience issues. A first device may detect its temperature meets a first prerequisite for transferring an operation from the first device to a second device and may responsively transfer the operation to the second device contingent on a temperature of the second device meeting a second prerequisite for the transferring of the operation to the second device. To facilitate this, each device may apply a respective temperature sensor to measure its temperature. Further, the devices may present user prompts to allow user control over whether to have the operation be transferred from one device to the other or rather to let a default action such as thermal throttling occur.

### BACKGROUND

People today have come to rely on electronic devices, such as mobile devices, to carry out many useful operations. By way of example, people often use devices such as smartphones, tablet computers, laptops, smartwatches, and other devices to carry out operations such as capturing photos, videos, and audio, engaging in network-based calls and other interactions with others, and providing navigation assistance, among numerous others. Especially with advances in technology, people have come to expect that their devices will carry out these operations reliably and efficiently.

### SUMMARY

One technical challenge with some devices relates to their handling of thermal state.

In general, the temperature of electronic devices may increase as the devices convert electrical energy into heat energy. For instance, as electric current flows through components of a device, the current typically encounters resistance that may result in power dissipation, where some of the electrical energy gets converted to heat. Further, as devices work to convert electrical energy into other forms (such as to generate light or sound or to engage in other work), that conversion process may be inefficient, resulting in some of the energy being converted to waste heat instead. Still further, modern devices having integrated circuits may contain billions of transistors that switch on and off rapidly, with that switching generating heat. Likewise, running processors (e.g., microprocessors) at high speeds in order to carry out intensive tasks or for other reasons, may increase power consumption and associated heat generation.

Some devices may include physical components such as heat sinks and fans to help manage this temperature increase. However, due to design constraints and for other reasons, that technology may be inadequate and may therefore still allow heat buildup during use.

To help prioritize user safety and extend device lifespan in view of this heat issue, engineers may configure devices to engage in thermal throttling. Thermal throttling may involve a device detecting when its temperature rises to a threshold level and responsively reducing its performance and power consumption in an effort to slow or reverse the temperature increase. Further, a device may apply progressively higher levels of throttling as its temperature increases to higher threshold levels.

Unfortunately, however, while thermal throttling may be effective in safeguarding the user and the device, the throttling may have unintended consequences, potentially hindering productivity and overall user experience. For instance, thermal throttling may degrade certain operations of the device, resulting in undesirably poor performance and therefore poor user experience.

By way of example, if a device is engaged in video recording and its temperature rises to a threshold level, the device may programmatically respond to that high temperature by reducing the frame rate or per-frame resolution of its video recording process, in an effort to reduce its work and associated heat generation. However, these actions may result in degraded quality of the resulting video.

As another example, if a user is engaged in a video call on a smartphone and the smartphone's operating temperature becomes threshold high, the smartphone may automatically throttle its video communication, such as by reducing frame rate, resolution, and/or transmission/reception speed (e.g., modulation scheme), to help reduce the temperature rise and/or reduce the temperature. However, the user and/or another participant in the video call may perceive these changes as poor video quality.

Poor user experience resulting from thermal throttling may unfortunately dissuade users from using their devices to engage in certain operations and may in some cases push users to look for other devices that can offer uninterrupted performance even under high thermal stress.

The present disclosure provides a technical mechanism that may help to overcome this issue. In accordance with the disclosure, when a device detects that its temperature has become threshold high, the device may work to transfer an operation of the device to another device, contingent on the other device's temperature not being threshold high. For example, if a first device is engaged in video recording of a scene and the first device's temperature gets high enough, the first device may responsively work with a second device to cause the second device to take over the video recording of the scene if the second device's temperature is not itself too high. With this example, this process may thus enable continued video recording of the scene potentially without degrading quality of the video recording such as reducing frame rate or resolution, which may help to improve user experience.

Accordingly, in one respect, disclosed is a method for use of device temperature as a basis to control transfer of an operation from one device to another. An example of this method may include a first device detecting that a temperature of the first device meets a first prerequisite for transferring an operation from the first device to a second device. Further, the example method may include, responsive to at least the detecting that the temperature of the first device meets the first prerequisite for transferring the operation from the first device to the second device, transferring the operation from the first device to the second device contingent on a temperature of the second device meeting a second prerequisite for the transferring of the operation from the first device to the second device.

This example method may further include the first device allowing a user to control whether the first device should transfer the operation to the second device or should rather engage in its default operation that may include associated thermal throttling. For instance, upon detecting that the temperature of the first device is threshold high, the first device may present a prompt for user approval of the transferring of the operation from the first device to the second device. In turn, upon receiving user approval in response to the presented prompt, the first device may then engage in processing to transfer the operation to the second device.

Example implementations of this process may include scenarios where a user possesses or otherwise has access to two devices, such as two smartphones, or a smartphone and a tablet computer, where the user is using one of the devices to engage in an operation, and where, in response to at least a temperature-based trigger detected by that device, that device works with the other device to transfer of the operation to the other device, so as to allow the operation to continue with limited or no interruption.

In another respect, disclosed is a first device, including a wireless communication interface, a processor, non-transitory data storage, and program instructions stored in the non-transitory data storage and executable by the processor to carry out operations such as those noted above.

Further, in another respect, disclosed is non-transitory data storage having stored thereon program instructions executable by a processor of a first device to carry out operations such as those noted above.

Still further, in another respect, disclosed is a computer program, such as an operating system or application logic for instance, comprising program instructions executable by a processor of a device to carry out operations such as those noted above.

Yet further, in another respect, disclosed is a computing system including a first device and a second device. In this system, the first device may have a first wireless communication interface, a first temperature sensor, a first processor, first non-transitory data storage, and first program instructions stored in the first non-transitory data storage and executable by the first processor to carry out operations of the first device. Further, the second device may have a second temperature sensor, a second processor, second non-transitory data storage, and second program instructions stored in the second non-transitory data storage and executable by the second processor to carry out operations of the second device.

In this system, the operations of the first device may include (i) detecting, based on sensing by the first temperature sensor, that a temperature of the first device meets a first prerequisite for transferring an operation from the first device to the second device and (ii) based at least on the detecting that the temperature of the first device meets the first prerequisite for transferring an operation from the first device to the second device, transferring the operation from the first device to the second device. Further, the operations of the second device may include (i) detecting, based on sensing by the second temperature sensor, that a temperature of the second device meets a second prerequisite for transferring the operation from the first device to the second device, and (ii) based at least on the detecting that the temperature of the second device meets the second prerequisite for transferring the operation from the first device to the second device, allowing transfer of the operation from the first device to the second device.

These, as well as other aspects, advantages, and alternatives, will become apparent to those of ordinary skill in the art by reading the following detailed description, with reference where appropriate to the accompanying drawings. Further, it should be understood that the disclosure provided here and elsewhere in this document is provided by way of example only and that numerous variations and other examples may be possible as well.

### BRIEF DESCRIPTION OF THE DRAWINGS

FIG. 1 is a simplified diagram depicting an example method.

FIG. 2 is a simplified illustration of an example operation-transfer process

FIG. 3 is a simplified block diagram of an example device.

FIG. 4 is a flow chart depicting an example method.

### DETAILED DESCRIPTION

This description will discuss example implementation in a scenario where the first and second devices may be smartphones, and where the operation to be transferred between the first device and second device may be an operation such as video recording, engaging in a video call, or engaging in network-based gaming. It should be understood, however, that the arrangements and processes described could take various other forms and could extend to apply in many other contexts, such as with different types of devices and/or with different types of operations, not limited to those described.

More generally, it should be understood that many variations are possible. For instance, disclosed elements and operations could be re-ordered, distributed, replicated, combined, omitted, added, or otherwise modified. Still further, elements described as functional entities could be implemented as discrete or distributed components or in conjunction with other components/modules, and in any suitable combination and location. In addition, various operations described as being carried out by one or more components or other entities could be implemented by and/or on behalf of those entities, through hardware, firmware, and/or software, such as by one or more processing units executing program instructions stored in memory, among other possibilities.

As noted above, the present disclosure provides a mechanism for use of device temperature as a basis to control transfer of operation from one device to another.

Typically, such a device would be configured to throttle its operations when the device's temperature rises to a threshold level, possibly engaging in progressively higher levels of throttling as its temperature increases. However, although this throttling may help to avoid overheating and associated damage, the throttling may unfortunately also result in poor user experience as noted above.

The present disclosure thus provides a mechanism that may help to overcome or mitigate this problem.

In accordance with the disclosure as noted above, when a first device is engaged in an operation and the temperature of the first device reaches a threshold state (e.g., becomes threshold high and/or is rising at a threshold high rate), the first device will take action to transfer the first device's operation to a second device, with the transfer being conditioned upon the temperature of the second device not being at a threshold state (possibly the same threshold state or another threshold state). Transferring the first device's operation to the second device may thereby enable the first device to cool down. Further, conditioning this transfer on a determination that the temperature of the second device is not at a threshold state may help increase a likelihood that the operation can usefully continue on the second device without thermal throttling by the second device.

To facilitate this, the first device and second device may establish a communication session (e.g., short-range wireless communication session) with each other, and the first device and second device may engage in signaling through that session to transfer the first device's operation to the second device. Further, the devices may make establishing of this communication session contingent on the temperature of the second device not being at a threshold state, so that, if the temperature of the second device is at a threshold state, the devices would not establish the communication session and the first device's operation would thus not be transferred to the second device. Alternatively or additionally, through signaling within the communication session, the devices may make transferring of the first device's operation to the second device contingent on the temperature of the second device not being at a threshold state.

To provide an improved user experience, when the first device detects that the temperature of the first device is at a threshold state, and possibly once the first device and second device have established their communication session and confirmed that the temperature of the second device is not at a threshold state, the first device may present a prompt to a user of the first device, seeking user approval to transfer the first device's operation to the second device. Upon receipt of user approval in response to that presented prompt, the first device may then engage in processing, including signaling with the second device for instance, to transfer the first device's operational state to the second device.

This prompting may usefully enable the user to exert some control over a performance mode of the first device. For instance, the prompting may allow the user to choose whether (i) to have the first device continue with default throttling of the first device's performance due to the temperature of the first device or (ii) to have the first device transfer the first device's operation to the second device to possibly permit the operation to continue on the second device without throttling.

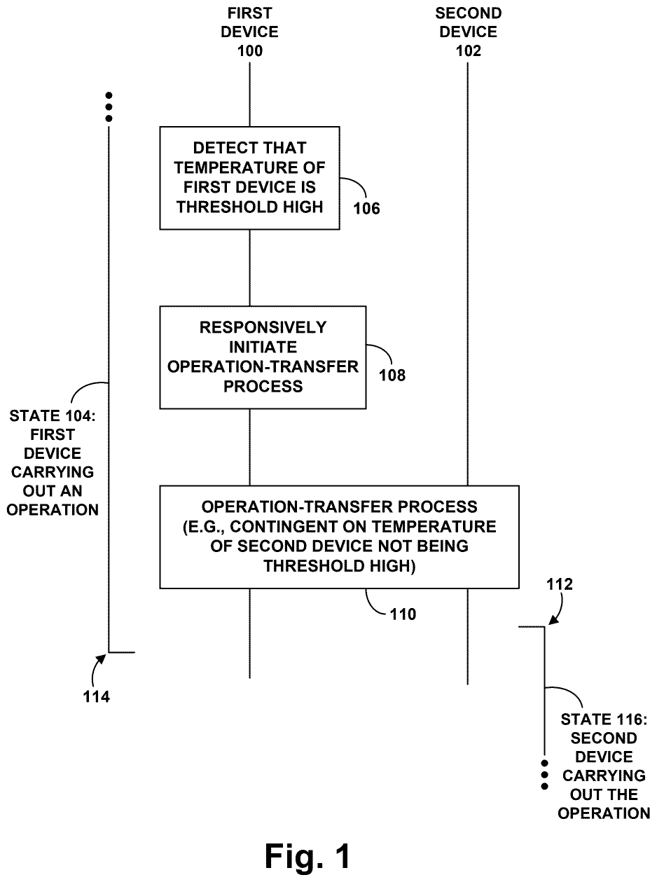

FIG. 1 is a simplified diagram illustrating an example implementation of this process involving a first device 100 and a second device 102.

As shown in FIG. 1, in an initial state 104, the first device 100 is engaged in an operation, such as one of those noted above for instance, and the second device 102 is not engaged in that operation. By way of example, (i) the first device 100 may be in use recording video of a scene, and the second device 102 may not be in use recording video, (ii) the first device 100 may be in use engaged in a video or audio call, and the second device 102 may not be in use engaged in such a call, or (iii) the first device may be in use engaged in network-based gaming, and the second device 102 may not be in use engaged in the network-based gaming.

While in that initial state 104, at step 106, the first device 100 detects that a temperature of the first device 100 is threshold high (e.g., that the temperature of the first device 100 is rising to or has risen to a predefined threshold high temperature level). For instance, the first device 100 may include one or more temperature sensors strategically positioned in and/or on the first device 100 to monitor temperature of the first device 100, and a processor of the first device 100 may detect, based on sensing by and output from the one or more temperature sensors of the first device 100, when the temperature of the first device 100 is threshold high.

For this purpose, the processor of the first device 100 may be pre-provisioned with an indication of a threshold temperature level and may thus compare sensed temperature of the first device 100 with that threshold temperature level to determine if the temperature of the first device 100 is threshold high. Alternatively or additionally, the threshold temperature level may be established based on data regarding the temperature level at which the first device 100 and/or devices more generally tend to engage in thermal throttling, such as by setting the threshold to a level just below that trigger level, in an effort to facilitate proactive operation transfer instead of thermal throttling.

At step 108, in response to detecting that the temperature of the first device 100 is threshold high, the first device 100 then initiates an operation-transfer process 110 in an effort to transfer the operation from being carried out by the first device 100 to being carried out instead by the second device 102 contingent on a temperature of the second device not being threshold high.

Initiating this operation-transfer process may assume that the first device 100 has information indicating the second device 102 to which the operation may be transferred, such as a device identifier, network address, or other information that facilitates coordinating the operation transfer to the second device 102. In some implementations, the first device 100 may be pre-provisioned with this information. In other implementations, in response to the first device 100 detecting that its temperature is threshold high, the first device may prompt a user of the first device to identify the second device 102. For instance, the first device 100 may detect one or more nearby devices (e.g., based on advertising signaling), may present a prompt for a user of the first device to select or confirm one such device to be the second device 102 for the transfer process, and may receive an associated response from the user.

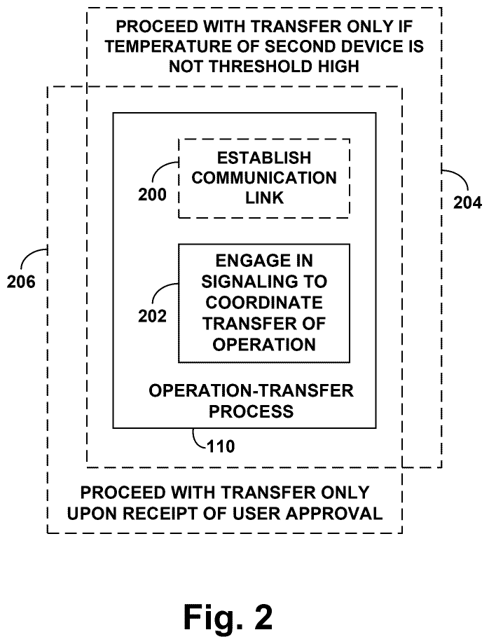

FIG. 2 illustrates an example of this operation-transfer process. As shown in FIG. 2, at block 200, the operation-transfer process 110 may include establishing a wireless communication link between the first device 100 and the second device 102 if such a communication link between the devices does not yet exist. Further, at block 202, the operation-transfer process 110 may include the first device 100 and second device 102 engaging in signaling with each other, possibly through their wireless communication link, to coordinate transfer of the operation from being carried out by the first device 100 to being carried out instead by the second device 102.

A wireless communication link between the devices for present purposes could take various forms. If the devices are positioned near enough to each other, this communication link could be a short-range wireless link, such as a BLUETOOTH link, a WIFI link, a ZIGBEE link, or another type of link. The devices may use known processing to establish this link. For instance, one device may advertise its presence, the other device may detect the advertisement and may responsively request a connection, and the devices may then engage in further signaling to complete establishment of the connection. Alternatively, if the devices are not positioned near enough to each other, and/or in other implementations, the devices may establish a different type of communication link with each other, such as a link through a cellular or other network system.

In alternative implementations, the devices may not establish a communication link with each other in order to engage in signaling with each other to coordinate transfer of the operation from the first device 100 to the second device 102. Instead, for instance, the devices may engage in asynchronous signaling, such as Short Message Service (SMS) messaging or other ad-hoc messaging, with each other to coordinate the operation transfer.

The signaling between the first device 100 and second device 102 to coordinate transfer of the operation from the first device 100 to the second device 102 could take various forms.

By way of example, this signaling may involve the first device 100 transmitting to the second device 102 signaling indicating the operation and defining a request for the second device 102 to start engaging in the operation.

That signaling may specifically point out, link to, or otherwise designate an application or the like on the second device 102 that would carry out the operation, possibly corresponding with an application on the first device that is currently carrying out the operation. For instance, if the operation is video recording, the signaling may designate a video recording application or other function to be invoked. Further, the signaling may provide any other information that would be necessary to enable the second device 102 to start engaging in the operation.

The second device 102 may thus receive this signaling from the first device 100, and in response to at least this signaling, may start engaging in the indicated operation. For instance, the second device 102 may initiate use of appropriate application program logic and/or one or more other features of the second device 102 to start carrying out the operation.

Depending on the operation at issue, this transfer of the operation from the first device 100 to the second device 102 may also involve either or both devices signaling with a network entity. For instance, if the operation initially involves the first device 100 interacting with a network based server (e.g., a call server, a media server, or a gaming server), the transfer may involve (i) the first device 100 signaling to that server to indicate the desired transfer of the operation to the second device 102 and to receive from the server an anchor address (e.g., a network address) at the server 102 to be used for the transfer, (ii) the first device 100 transmitting that anchor address to the second device 102, and (iii) the second device then engaging in signaling with the server at that anchor address so as to facilitate having the second device 102 establish communication with the server and take over the interaction with the server.

Further, the signaling between the first device 100 and the second device 102 to coordinate transfer of the operation from the first device 100 to the second device 102 may also involve the second device 102 transmitting to the first device 100 a confirmation that the second device 102 has begun engaging in the indicated operation. This confirmation signaling may be a trigger for the first device 100 to then discontinue its own engaging in the operation. Namely, upon learning that the second device 102 has started carrying out the operation, the first device 100 may then stop carrying out the operation. This may thereby constitute a make-before-break transfer of the operation from the first device 100 to the second device 102, wherein the second device 102 starts carrying out the operation before the first device 100 stops carrying out the operation. Alternatively, the first device 100 may stop carrying out the operation before the second device 102 starts carrying out the operation.

As shown by block 204 in FIG. 2, some or all of the operation-transfer process 110 could be made contingent on the temperature of the second device 102 not being threshold high. This can help achieve the useful technical effect of helping to avoid transferring the operation to the second device 102 if and when doing so would exacerbate an already-high thermal state at the second device 102.

To facilitate this, the second device 102 may determine its own temperature. For instance, the second device 102 may likewise include one or more temperature sensors strategically positioned in and/or on the second device 102 to monitor temperature of the second device, and a processor of the second device 102 may learn the temperature of the second device 102 based on sensing by and output from the one or more temperature sensors of the second device 102, and may thereby detect when the temperature of the second device 102 is threshold high.

As with the temperature evaluation at the first device 100, the processor of the second device 102 may be pre-provisioned with an indication of a threshold temperature level and may thus compare sensed temperature of the second device 102 with that threshold temperature level to determine if the temperature of the second device 102 is threshold high. Alternatively or additionally, the threshold temperature level may be established based on data regarding the temperature level at which the second device 102 and/or devices more generally tend to engage in thermal throttling, such as by setting the threshold to a level just below that trigger level, in an effort to facilitate proactive operation transfer instead of thermal throttling.

Making some or all aspects of the operation-transfer process 110 contingent on the temperature of the second device 102 not being threshold high may then take various forms.

By way of example, establishing a wireless communication link between the first device 100 and the second device 102 through which the devices could engage in signaling to facilitate the operation transfer could be made contingent on the temperature of the second device 102 not being threshold high.

For instance, the second device 102 could make a determination of whether the temperature of the second device 102 is at least as high as a threshold level that is deemed to be too high to justify the second device 102 taking over the operation. If the determination is affirmative (i.e., the temperature of the second device 102 is too high), then, based at least on the determination, the second device 102 could programmatically decline to establish the communication link with the first device 100, which may thereby preclude transfer of the operation from the first device 100 to the second device 102. Whereas, if the determination is not affirmative (i.e., the temperature of the second device 102 is not too high), then, based at least on the determination, the second device 102 could programmatically allow the communication link with the first device 100 to be established.

As another example, aside from any control over establishing a communication link between the devices, the transfer of the operation from the first device 100 to the second device 102 through signaling between the devices could be made contingent on the temperature of the second device 102 not being threshold high. For instance, through signaling between the devices, the second device 102 may specify the temperature of the second device 102 (or an indication of that temperature, such as a range or corresponding index value), and the first device 100 may decide based on that specified temperature of the second device 102 whether to proceed with transferring the operation to the second device 102, with the first device 100 declining to proceed with the transfer if the temperature of the second device 102 is too high, and otherwise proceeding with the transfer. Alternatively, the second device 102 itself may decline to proceed with the transfer if the temperature of the second device 102 is too high, or may otherwise allow the transfer to occur.

In addition, as shown by block 206 in FIG. 2, some or all of the operation-transfer process 110 may be contingent on a user of the first device 100 approving the transfer and/or on a user (e.g., the same user) of the second device 102 approving the transfer.

For instance, before the first device 100 proceeds with an action such as establishing the communication link with the second device 102 and/or engaging in the signaling with the second device 102 to coordinate transfer of the operation from the first device 100 to the second device 102, the first device 100 may present a prompt (e.g., visual and/or audio) for user approval of the transfer of the operation and may then make a determination of whether the first device 100 receives the user approval in response to the prompt. If the determination is affirmative, then, based at least on the determination, the first device 100 may then proceed with the action. Whereas, if the determination is negative, then, based at least on the determination, the first device 100 may decline to proceed with the action and may thus decline to proceed with the transfer of the operation.

Alternatively, or additionally, before the second device 102 proceeds with an action such as establishing the communication link with the first device 100, engaging in signaling with the first device 100 to coordinate transfer of the operation from the first device 100 to the second device 102, or otherwise allowing that transfer to occur, the second device 102 may present a prompt (e.g., visual and/or audio) for user approval of the transfer of the operation and may then make a determination of whether the second device 102 receives the user approval in response to the prompt. If the determination is affirmative, then, based at least on the determination, the second device 102 may proceed with the action, thus allowing the transfer of the operation to occur. Whereas, if the determination is negative, then, based at least on the determination, the second device 102 may decline to proceed with the action, thus not allowing the transfer of the operation to occur.

Accordingly, at step 110 in FIG. 1, in response to the first device 100 detecting that its temperature is threshold high, and possibly contingent on temperature of the second device 102 not being too threshold high and/or on the first device 100 and/or second device 102 receiving user approval for the transfer, the first device 100 and second device 102 then engage in the operation transfer process, causing the second device 102 to start carrying out the operation at point 112 and causing the first device 100 to stop carrying out the operation at point 114.

This temperature-based transfer of the operation from being carried out by the first device 100 to being carried out instead by the second device 102 thus transitions the devices from the initial state 104 to a new state 116 in which the second device 102 is engaged in the operation and the first device 100 is not engaged in the operation. In this second state 116, because the first device 100 is no longer carrying out the operation, the first device 100 may thereby cool down, possibly then facilitating a transfer of the operation back from the second device 102 to the first device 100.

This process may thus facilitate continued carrying out of the operation possibly without a need for either device to engage in thermal throttling and thus without the associated user experience issues.

The disclosed process could facilitate transfer from the first device 100 to the second device 102 of various operations that may be associated with device-temperature rise. Without limitation, three examples are (i) a video recording session, (ii) a video call, and (iii) a gaming session.

If the first device is currently recording video of a scene, for example, and if the temperature of the first device rises to a threshold state and the temperature of the second device is not at a threshold state, the first device may cause the second device to take over the function of video recording of the scene.

For instance, consider a scenario where a user A is using smartphone A to record video of a scene when the user A is with user B who has a smartphone B that is not being used to record video of the scene. In that scenario, smartphone A may detect that temperature of smartphone A is threshold high (e.g., nearly at a point where smartphone A may trigger application of thermal throttling). In response, smartphone A may then engage in signaling with nearby smartphone B to determine that smartphone B can receive the operation transfer, e.g., based on temperature of smartphone B not being threshold high and possibly based on smartphone B prompting for and receiving user approval of the operation transfer. Smartphone A may then present a prompt for user approval of the operation transfer, which may state something like “Transfer video recording function to B's phone to help avoid performance reduction due to device temperature? ” Upon receipt of approval from user A, smartphone A may then engage in further signaling with smartphone B to transfer the operation from being carried out by smartphone A to being carried out instead by smartphone B.

With this example implementation or the like, the first and second devices may each end up storing a respective video file as a respective portion of the video recording of the scene. For instance, the first device 100 may end up with a stored video recording of the scene that runs up until the time the first device 100 stopped video recording, and the second device 102 may end up with a stored video recording of the scene that starts at the time the second device 102 took over the video recording of the scene.

To manage these two pieces of the video recording of the scene, the devices may mark their respective files with metadata to indicate the relationship between the recordings. Further, through a communication link between the devices or through cloud-server-based media syncing, one of the devices and/or another computing system may then pair up and merge the files together to form a unitary video file that includes video recorded by both the first device 100 and video recorded by the second device 102.

To help facilitate this video merging, for instance if the devices record the scene from somewhat different angles than each other, either or both devices could make special use of a zoom feature, namely dynamically controlling how zoomed in or out a video function is (e.g., by optical zooming or digital zooming) and thus how wide of a view of the scene is being captured.

For instance, to facilitate the merging, the second device 102 could be configured to start its video recording zoomed out as much as possible before then optionally zooming in, and/or the first device 100 could be made to zoom out as much as possible before ending its video recording. That way, a computing system that would merge the videos together, possibly fading from one to the other, could digitally zoom in to the extent desired to help match or at least sensibly fade from one recording to the other. In some implementations, this may also involve at least one of the devices communicating its zoom level to the other device, and other device using that indicated zoom level to help ensure that the other device zooms out beyond that zoom level, i.e., wider than that zoom level, to help facilitate this merging process. Further, configuring the operation transfer as a make-before-break process as noted above may help provide some overlap to facilitate fading from one recording to the other.

As another example, if the first device 100 is currently engaged in a video call with a remote party, possibly through a video call server, and if the temperature of the first device 100 rises to a threshold state and the temperature of the second device 102 is not at a threshold state, the first device 100 may invoke a handover of that video call to the second device 102. For instance, the first device 100 may engage in signaling with the second device 102 to convey to the second device 102 various video-call state parameters, and the first device 100 may engage in signaling with the video call server or the remote party to facilitate this transfer, possibly as noted above. This handover may also be a make-before-break process, to be most seamless.

As yet another example, if the first device 100 is currently engaged in a gaming session served by a gaming server and if the temperature of the first device rises to a threshold state and the temperature of the second device 102 is not at a threshold state, the first device 100 may trigger a handover of that gaming session the second device 102. For instance, the first device 100 may engage in signaling with the second device 102 to convey to the second device 102 various game state parameters, and the first device 100 may engage in signaling with the gaming server to facilitate this transfer. This handover may also be a make-before-break process, to be most seamless.

As noted above, the temperature threshold(s) in this process could be predefined and/or could be dynamically established based on historical use data that may be specific to the first device 100, the second device 102, and/or other devices possibly of the similar type, and based on operational state of such devices. For instance, historical device operation and usage logs may establish on a particular device-types basis (e.g., per make/model) what device temperature and/or temperature change tends to cause a device to start applying thermal throttling. Based on that information, a device could thus be set with an associated threshold for device temperature to help proactively trigger operation transfer when possible. This dynamic threshold setting could be done by a given device based on its own historical data, causing the device to set its own threshold level for the process. Alternatively, the dynamic threshold setting could be done by another computing system, possibly based on usage data as to potentially many devices of the same type, and the computing system could then provision such a device with the associated threshold level.

Alternatively, either or each device could have a manufacturer specification or the like that indicates a temperature at which the device is to start applying thermal throttling, and the device may be provisioned with a threshold level based on this specification. Still further, a device may provide a user interface through which the device could receive user input specifying a temperature threshold to be applied by the device as a key for starting to apply thermal throttling, possibly limiting user control of this setting to help ensure that the threshold is in a safe range.

Furthermore, the act of detecting whether a device's temperature meets a prerequisite (e.g., that the temperature of the first device 100 is threshold high or that the temperature of the second device 102 is not threshold high) for engaging in the present operation-transfer process, and for consequently triggering or allowing the operation-transfer process, could make use of artificial-intelligence processing. For instance, either device may be programmed with a machine-learning model (e.g., a neural-network based model) that is trained, based on input data defining various combination of device-operational factors, to predict the onset of thermal throttling, effectively detecting that a device's temperature is at or approaching a state when the device will start applying thermal throttling.

By way of example, a computing system may train such a machine-learning model based on historical device operation and usage logs reported from many devices. The training data may take the form of many input vectors each correlating (i) multi-variable operational state at a given moment in time when the thermal throttling was not active with (ii) an indication of whether or not thermal throttling was active some predefined duration after that given moment in time.

For instance, based on the historical device operation and usage logs respectively of each of many devices, a computing system may establish these training vectors. Each vector may define a snapshot in time of operational state of a given device at a respective moment in time when the device was not applying thermal throttling, indicating for that moment in time what operation or operations the device was engaged in, what the device's remaining battery energy was (if applicable), what change in the device's temperature the device recently experienced, what the device's current operating temperature is, and various sensor readings of the device regarding environmental conditions, as well as data regarding the type (e.g., make/model) of device, and indicating whether or not the device was then applying thermal throttling at a predefined duration of time (e.g., 10 seconds, one minute, a few minutes, or some other duration) after that moment in time.

Training a machine-learning model based on this data may establish weightings for neural-network nodes and connections that may enable the machine-learning model to then predict whether, given a current set of operational state information of a given device, the device will invoke thermal throttling within the predefined duration of time. For instance, given an input vector that indicates the operation or operations in which the device is currently engaged, the device's current remaining battery energy, the device's most recent change in temperature, the device's current temperature, and the device's make/model, the model may predict whether or not the device will invoke thermal throttling within the predefined duration.

Each device, such as the first device 100 and the second device 102 for instance, may then be provisioned with this trained machine-learning model and may use the model as a basis to predict when they are likely to apply thermal throttling, as a form of detecting when their temperature is threshold high or otherwise at a threshold state that may trigger thermal throttling. In practice, the first device 100 may use this trained machine-learning model as a basis to detect that the temperature of the first device 100 is threshold high and to responsively trigger the operation-transfer process described herein. Further, the second device 102 may use this trained machine-learning model as a basis to determine that its temperature is not threshold high and thus to allow the operation-transfer process to occur.

Note also that, with embodiments that involve a device reporting its historical operation and usage logs, a user of the device may be provided with controls that allow the user to make an election of whether to allow collection and/or use of such information. Further, certain data may be treated in one or more ways before it is stored or used, so that personally-identifiable information is removed. For example, any user identity information may be treated so that no personally identifiable information can be determined for the user, or a user's geographic location may be generalized so that a particular user's location cannot be determined. Thus, the user may have control over what information is collected about the user and how that information is used.

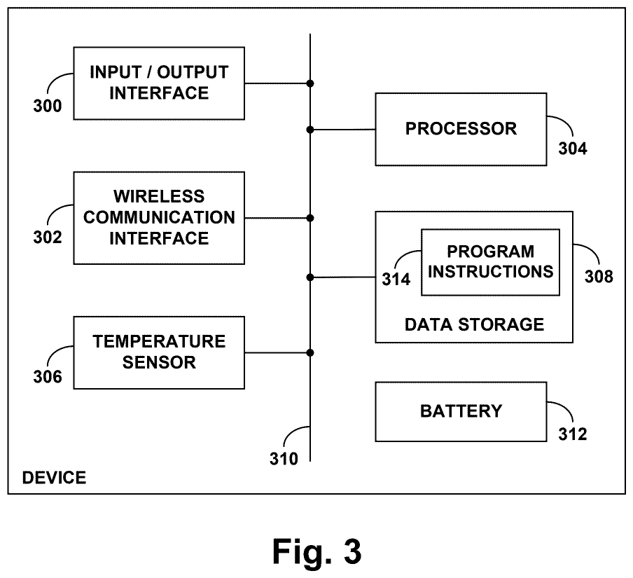

FIG. 3 is a simplified block diagram of an example device, which could be the first device 100 or second device 102 of FIG. 1 for instance.

As shown in FIG. 3, the example device includes an input/output interface 300, a wireless communication interface 302, a processor 304, a temperature sensor 306, and non-transitory data storage 308, which may be integrated together and/or interconnected by a system bus, network, or other connection mechanism 310. Further, the example device includes a battery 312 or other power source for providing energy to drive operation of the various device components, e.g., through a power bus (not shown).

The input/output interface 300 could include input and output components to facilitate interaction with a user of the device and other input/output of media such as video and audio. For instance, the input/output interface 300 could include input components such as a camera for capturing still images and video, a microphone for capturing audio, a keypad for receiving keypresses, and a touch-sensitive panel for receiving touch input. Further, the input/output interface 300 could include output components, such as a display screen (possibly including the touch-sensitive panel) for presenting video, graphics, and other content, and a sound speaker for presenting audio.

The wireless communication interface 302 could include a short, medium, and/or long range wireless communication interface, such as any of those noted above for instance. By way of example, the wireless communication interface 302 could include an BLUETOOTH module and/or Wi-Fi module, with associated radio(s), antennas, baseband processors, and other components to facilitate wireless communication between the device and other devices and systems.

The processor 304 could comprise one or more general purpose processors (e.g., microprocessors) and/or one or more specialized processors (e.g., digital signal processors (DSPs), graphics processing units (GPUs), neural processing units (NPUs), etc.)

The temperature sensor 306 may comprise one or more temperatures sensors that may be strategically positioned in and/or on the device to facilitate monitoring the physical temperature of the device, so as to facilitate temperature-based control over operation transfer as discussed herein. This may include one or more micro sensors positioned at hotspots in the device, such as near a processor chipset, near one or more antennas, near audio speakers, and near a display panel, among other possibilities. The device may be configured to feed an output with ongoing sensor readings (or threshold based sensor output) from each sensor to the processor 304, to enable the processor 304 to evaluate device temperature. In some implementations, where there are multiple sensor readings from different places in or on the device, the processor 304 may average or otherwise aggregate or roll up those readings to produce a “virtual skin temperature” of the device, which the processor may use as a representative temperature of the device for present purposes. Other arrangements are possible as well.

The non-transitory data storage 308 could comprise one or more volatile and/or non-volatile storage components (e.g., flash, optical, magnetic, read only memory (ROM), random access memory (RAM), electronically programmable read only memory (EPROM), electronically erasable programmable read only memory (EEPROM), etc.), which may be integrated in whole or in part with the processor 304.

As further shown, the non-transitory data storage 308 could store program instructions 314. These instructions 314 may define an operating system and applications of the device and may be executable by the processor 304 to carry out (i.e., cause the device to carry out) various device operations described herein.

The battery 312 could be configured to provide energy to support operation of the example device when the device is not connected with another energy source. For instance, the battery 312 could provide energy to drive components such as those noted above. The battery 312 could be rechargeable and could take various forms, examples of which include nickel metal hydride (NiMH), nickel cadmium (NiCd), Lithium Ion (Li-Ion), and lithium polymer (Li-Poly). Further, the battery 312 may include or be interconnected with a battery-level monitor (not shown), which may function to monitor remaining battery energy of the battery 312 and to report the remaining battery energy to the processor 304 for reference.

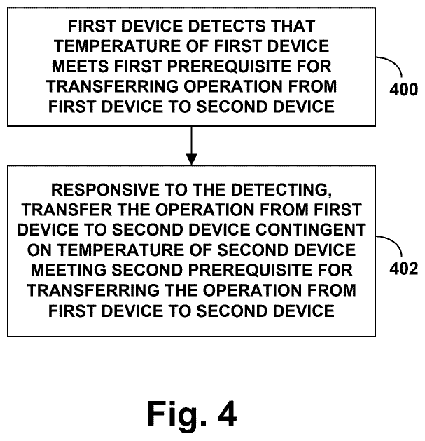

FIG. 4 is a flow chart depicting an example method that could be carried out in accordance with example implementations. As shown in FIG. 4, at block 400, the example method includes a first device detecting that a temperature of the first device meets a first prerequisite for transferring an operation from the first device to a second device. Further, at block 402, the method includes, responsive to at least the detecting, transferring the operation from the first device to the second device contingent on a temperature of the second device meeting a second prerequisite for the transferring of the operation from the first device to the second device.

In line with the discussion above for instance, the act of the first device detecting that the temperature of the first device meets the first prerequisite for transferring the operation of the first device to the second device could involve the first device applying at least a first temperature sensor to sense the temperature of the first device and detecting by the first device that the sensed temperature of the first device is at least as high as a predefined threshold level.

Further, as discussed above for instance, the act of transferring the operation from the first device to the second device responsive to at least the detecting by the first device that the temperature of the first device meets the first prerequisite for transferring the operation from the first device to the second device could involve (i) the first device presenting a prompt for approval of the transferring of the operation from the first device to the second device, (ii) the first device receiving, in response to the presented prompt, approval of the transferring of the operation from the first device to the second device, and (iii) transferring the operation from the first device to the second device in response to at least receiving of the approval.

As further noted above for instance, the act of transferring the operation from the first device to the second device contingent on the temperature of the second device meeting the second prerequisite for transferring the operation from the first device to the second device could involve (i) the first device making a determination of whether the temperature of the second device meets the second prerequisite for transferring the operation from the first device to the second device and (ii) based at least on the determination being that the temperature of the second device meets the second prerequisite for transferring the operation from the first device to the second device, transferring the operation from the first device to the second device.

Alternatively or additionally, as discussed above for instance, the act of transferring the operation from the first device to the second device contingent on the temperature of the second device meeting the second prerequisite for transferring the operation from the first device to the second device could involve (i) the second device making a determination of whether the temperature of the second device meets the second prerequisite for transferring the operation from the first device to the second device and (ii) based at least on the determination being that the temperature of the second device meets the second prerequisite for transferring the operation from the first device to the second device, the second device allowing the transferring of the operation from the first device to the second device. For instance, the second device could allow the transfer of the operation by continuing with processing that facilitates the transfer.

As further noted above for instance, the second prerequisite for transferring the operation from the first device to the second device could include the temperature of the second device being at least as low as a predefined threshold low temperature or not being at least as high as a predefined threshold high temperature.

Further, as noted above for instance, the act of transferring the operation from the first device to the second device could involve (i) establishing a wireless communication link between the first device and the second device and (ii) the first device engaging in signaling with the second device over the established wireless communication link, with the signaling causing the second device to start carrying out the operation, and the first device then stopping carrying out of the operation.

Yet further, as discussed above for instance, the act of transferring the operation from the first device to the second device could involve the first device engaging in signaling with the second device over a pre-existing wireless communication link between the first device and the second device, with the signaling causing the second device to begin carrying out the operation, and the first device then stopping carrying out of the operation.

As still further discussed above for instance, the operation at issue could include video recording of a scene, in which case the act of transferring the operation from the first device to the second device could involve (i) the first device causing the second device to start video recording of the scene and (ii) after the second device starts video recording of the scene, the first device stopping video recording of the scene.

By way of example, as discussed above for instance, the act of the first device causing the second device to start video recording of the scene could involve transmitting from the first device to the second device a control signal to which the second device is configured to respond by starting to video record the scene. Further, the act of the second device starting to video record the scene could involve (i) the second device presenting a prompt for approval to start the video recording of the scene, (ii) the second device receiving, in response to the presented prompt, approval of starting the video recording of the scene, and (iii) the second device starting to video record the scene in response to at least receiving of the approval.

Furthermore, as discussed above for instance, the first device may video record the scene with a first zoom level, and the act of causing the second device to start video recording of the scene could involve causing the second device to start video recording of the scene with a second zoom level that is more zoomed out than the first zoom level, to help facilitate merging of a resulting first-device video recording of the scene with a resulting second-device video recording of the scene.

Alternatively or additionally, as discussed above for instance, the first device may video record the scene with a first zoom level, and the act of transferring the operation of the first device to the second device could involve, before the first device stops video recording of the scene, the first device zooming out from the first zoom level to a second zoom level, to help facilitate merging of a resulting first-device video recording of the scene with a resulting second-device video recording of the scene.

Still further, as discussed above for instance, the operation at issue could take other forms, such as engaging in a video call or engaging in a gaming session, among other possibilities.

In addition, the present disclosure also contemplates non-transitory data storage (e.g., one or more non-transitory computer-readable medium components (e.g., optical, magnetic, or flash storage, RAM, ROM, EPROM, EEPROM, cache memory, and/or other computer-readable media, etc.)) holding program instructions executable by at least one processor of a device to cause the device to carry out various operations described herein.

Further, the present disclosure also contemplates a computer program comprising a set of program instructions executable by at least one processor of a device to carry out (e.g., to cause the device to carry out) various operations described herein, such as to perform the various operations of the example methods and variations discussed above. In an example implementation, the computer program could further be stored in non-transitory data storage such as that noted above, among other possibilities.

Still further, as noted above, the present disclosure contemplates a computing system including a first device and a second device. As noted above, the first device may be configured to detect, based on sensing by a temperature sensor of the first device, that a temperature of the first device meets a first prerequisite for transferring an operation from the first device to the second device and, based at least on the detecting that the temperature of the first device meets the first prerequisite for transferring an operation from the first device to the second device, to transfer an operation from the first device to the second device. Further, the second device may be configured to detect, based on sensing by a temperature sensor of the second device, that a temperature of the second device meets a second prerequisite for transferring the operation from the first device to the second device, and, based at least on the detecting that the temperature of the second device meets the second prerequisite for transferring the operation from the first device to the second device, to allow transfer of the operation from the first device to the second device.

Example embodiments have been described above. Those skilled in the art will understand, however, that changes and modifications may be made to these embodiments without departing from the true scope and spirit of the invention.

What is claimed is:

1. A method comprising:
detecting by a first device that a temperature of the first device meets a first prerequisite for transferring an operation from the first device to a second device; and
responsive to at least the detecting, transferring the operation from the first device to the second device contingent on a temperature of the second device meeting a second prerequisite for the transferring of the operation from the first device to the second device.

2. The method of claim 1, wherein detecting by the first device that the temperature of the first device meets the first prerequisite for transferring the operation of the first device to the second device comprises applying by the first device at least a first temperature sensor to sense the temperature of the first device and detecting by the first device that the sensed temperature of the first device is at least as high as a predefined threshold level.

3. The method of claim 1, wherein transferring the operation from the first device to the second device responsive to at least the detecting by the first device that the temperature of the first device meets the first prerequisite for transferring the operation from the first device to the second device comprises:
presenting by the first device a prompt for approval of the transferring of the operation from the first device to the second device;
receiving by the first device, in response to the presented prompt, approval of the transferring of the operation from the first device to the second device; and
transferring the operation from the first device to the second device in response to at least receiving of the approval.

4. The method of claim 1, wherein transferring the operation from the first device to the second device contingent on the temperature of the second device meeting the second prerequisite for transferring the operation from the first device to the second device comprises:
making a determination by the first device of whether the temperature of the second device meets the second prerequisite for transferring the operation from the first device to the second device; and
based at least on the determination being that the temperature of the second device meets the second prerequisite for transferring the operation from the first device to the second device, transferring the operation from the first device to the second device.

5. The method of claim 1, wherein transferring the operation from the first device to the second device contingent on the temperature of the second device meeting the second prerequisite for transferring the operation from the first device to the second device comprises:
making a determination by the second device of whether the temperature of the second device meets the second prerequisite for transferring the operation from the first device to the second device; and
based at least on the determination being that the temperature of the second device meets the second prerequisite for transferring the operation from the first device to the second device, allowing by the second device the transferring of the operation from the first device to the second device.

6. The method of claim 1, wherein the second prerequisite for transferring the operation from the first device to the second device comprises the temperature of the second device being at least as low as a predefined threshold low temperature or not being at least as high as a predefined threshold high temperature.

7. The method of claim 1, wherein transferring the operation from the first device to the second device comprises:
establishing a wireless communication link between the first device and the second device; and
engaging by the first device in signaling with the second device over the established wireless communication link, wherein the signaling causes the second device to start carrying out the operation, and wherein the first device then stops carrying out the operation.

8. The method of claim 1, wherein transferring the operation from the first device to the second device comprises engaging by the first device in signaling with the second device over a pre-existing wireless communication link between the first device and the second device, wherein the signaling causes the second device to begin carrying out the operation, and wherein the first device then stops carrying out the operation.

9. The method of claim 1, wherein the operation comprises video recording of a scene.

10. The method of claim 9, wherein transferring the operation from the first device to the second device comprises:
causing, by the first device, the second device to start video recording of the scene;
after the second device starts video recording of the scene, stopping by the first device video recording of the scene.

11. The method of claim 10, wherein causing by the first device the second device to start video recording of the scene comprises transmitting from the first device to the second device a control signal to which the second device is configured to respond by starting to video record the scene.

12. The method of claim 11, wherein the second device starting to video record the scene comprises:
presenting by the second device a prompt for approval to start the video recording of the scene;
receiving by the first second, in response to the presented prompt, approval of starting the video recording of the scene; and
starting by the second device to video record the scene in response to at least receiving of the approval.

13. The method of claim 10, wherein the first device video records the scene with a first zoom level, and wherein causing the second device to start video recording of the scene comprises causing the second device to start video recording of the scene with a second zoom level that is more zoomed out than the first zoom level, to help facilitate merging of a resulting first-device video recording of the scene with a resulting second-device video recording of the scene.

14. The method of claim 10, wherein the first device video records the scene with a first zoom level, wherein transferring the operation of the first device to the second device further comprises:
before the first device stops video recording of the scene, zooming out by the first device from the first zoom level to a second zoom level, to help facilitate merging of a resulting first-device video recording of the scene with a resulting second-device video recording of the scene.

15. The method of claim 1, wherein the operation comprises engaging in a video call.

16. The method of claim 1, wherein the operation comprises engaging in a gaming session.

17. A first device comprising:
a wireless communication interface;
a processor;
non-transitory data storage; and
program instructions stored in the non-transitory data storage and executable by the processor to carry out operations including:
detecting that a temperature of the first device meets a first prerequisite for transferring an operation from the first device to a second device, and
responsive to at least the detecting, transferring the operation from the first device to the second device contingent on a temperature of the second device meeting a second prerequisite for the transferring of the operation from the first device to the second device.

18. A computing system comprising:
a first device having a first wireless communication interface, a first temperature sensor, a first processor, first non-transitory data storage, and first program instructions stored in the first non-transitory data storage and executable by the first processor to carry out operations of the first device; and
a second device having a second wireless communication interface, a second temperature sensor, a second processor, second non-transitory data storage, and second program instructions stored in the second non-transitory data storage and executable by the second processor to carry out operations of the second device,
wherein the operations of the first device include (i) detecting, based on sensing by the first temperature sensor, that a temperature of the first device meets a first prerequisite for transferring an operation from the first device to the second device and (ii) based at least on the detecting that the temperature of the first device meets the first prerequisite for transferring an operation from the first device to the second device, transferring the operation from the first device to the second device, and
wherein the operations of the second device include (i) detecting, based on sensing by the second temperature sensor, that a temperature of the second device meets a second prerequisite for transferring the operation from the first device to the second device, and (ii) based at least on the detecting that the temperature of the second device meets the second prerequisite for transferring the operation from the first device to the second device, allowing transfer of the operation from the first device to the second device.

19. The computing system of claim 18, wherein the operation comprises video recording of a scene.

20. The computing system of claim 18, wherein the operation comprises at least one of engaging in a video call or engaging in a gaming session.
